(19) United States
(12) Patent Application Publication
(10) Pub. No.: US 2024/0416311 A1
(43) Pub. Date: Dec. 19, 2024

(54) METHODS AND SYSTEMS FOR DELIMITING A GAS PLANT

(71) Applicant: KELLOGG BROWN & ROOT LLC, Houston, TX (US)

(72) Inventors: Madhavendra Kapkoti, Delhi (IN); Yi Yang, Pearland, TX (US); Rajeev Ranjan, Delhi (IN); Matthew James Griffiths, Arlington Heights, IL (US); Rahul Radhakrishna Pillai, Manvel, TX (US)

(73) Assignee: KELLOGG BROWN & ROOT LLC, Houston, TX (US)

(21) Appl. No.: 18/336,931

(22) Filed: Jun. 16, 2023

(51) Int. Cl. B01J 8/18; B01D 3/14; B01D 5/00; B01J 8/24

(52) U.S. Cl. CPC B01J 8/1872; B01D 3/14; B01D 5/006; B01D 5/009; B01J 8/1845; B01J 8/24; C10G 11/18

(57) ABSTRACT

Methods and systems are provided for delimiting a gas plant during fluid catalytic cracking unit (FCCU) revamp as part of the olefin production system. These methods and system include a chiller unit in the gas concentration unit downstream of the FCCU. Other measures also include installing a stripper unit downstream of the regenerator of the FCCU or installing a quench line in a reactor of a FCCU to reduce the contact time of the hydrocarbon feedstock with the catalyst. These methods and systems may also lead to an increase in the propylene yield of the olefin production system.

### TECHNICAL FIELD

The present disclosure relates to methods and systems for delimiting a gas plant, such as during a fluid catalytic cracking unit (FCCU) revamp. More specifically, the present disclosure relates to methods and systems for reducing a load on a gas compressor unit at a gas plant.

### BACKGROUND

Fluid catalytic cracking (FCC) in refineries is a key process for converting hydrocarbon feedstock to valuable petrochemicals, such as ethylene and propylene. The FCCU utilizes a reactor, known as a riser, to contact hydrocarbon feedstock with a catalyst to facilitate the conversion of a hydrocarbon feedstock into petrochemicals. Advancements in the FCCU technology, such as the dual riser technology (KBR MAXOFIN™ technology), employ multiple risers to facilitate the conversion of different hydrocarbon feedstocks, in the respective riser, into an effluent rich in ethylene and/or propylene. Increased demands for propylene have required modifications to existing gas plants to install new FCC equipment to maximize propylene yields. Gas plants that upgrade to the latest FFCU technology are readily capable of facilitating higher propylene yields. However, the magnitude of the propylene yields is often constrained by the original design of the gas plant.

### SUMMARY

Applicant has recognized that existing gas plants can maximize recovery of propylene by implementing one or more methods and systems described herein to delimit the gas plant.

Certain embodiments include an olefin production system to delimit a wet gas compressor in a gas concentration unit. In certain embodiments, an olefin production system comprises a fluid catalytic cracking unit, a fractionator, and a gas concentration unit containing an overhead condenser, a chiller, a receiver, and a wet gas compressor. The fluid catalytic cracking unit has a riser reactor and a regenerator and is configured to receive a hydrocarbon feedstock and produce a cracked product stream containing light and heavy paraffinic hydrocarbons, naphthas, aromatics and olefinic hydrocarbons. In certain embodiments, the riser reactor may include a quench line to introduce a quench fluid to the riser reactor at 1.5 seconds after the hydrocarbon feedstock is brought in contact with a catalyst. In certain embodiments, the riser reactor is a dual or a multi-riser reactor. The fractionator is in fluid communication with the fluid catalytic cracking unit and configured to receive and separate the cracked product stream into (i) a vapor product stream containing ethylene and propylene, and light naphtha, (ii) a first wild naphtha product stream, and (iii) a liquid products stream containing one or more of heavy naphtha, a light cycle oil, and a slurry oil. The overhead condenser is in fluid communication with the fractionator and configured to receive the vapor product stream and produce a first cooled fluid stream with a temperature ranging from about 105 degrees Fahrenheit (° F.) to about 120° F. The chiller, in the gas concentration unit, in fluid communication with the overhead condenser and configured to receive the first cooled fluid stream and produce a second cooled fluid stream with a temperature ranging from about 55° F. to about 100° F. The receiver, in the gas concentration unit, is in fluid communication with the chiller and configured to receive the second cooled fluid stream and separate the second cooled fluid stream to a wet gas stream containing the ethylene and the propylene and a second wild naphtha stream. The wet gas compressor, in the gas concentration unit, is in fluid communication with the receiver and configured to increase pressure of the wet gas stream containing the ethylene and the propylene to be supplied for downstream processing to produce an olefin enriched product stream. In certain embodiments, the wet gas compressor may increase the pressure of the wet gas stream from 20 pounds per square inch gauge (psig) to 225 psig to be supplied for the downstream processing. In certain embodiments, the temperature of the first cooled fluid stream may range from about 105° F. to about 115° F. In certain embodiments, the temperature of the second cooled fluid stream may range from about 55° F. to about 75° F. or from about 55° F. to about 65° F. In certain embodiments, the riser reactor is configured to receive two or more hydrocarbon feedstock streams and the catalyst. In certain embodiments, a volumetric flow rate of the wet gas stream is reduced by about 35 vol. % when the temperature of the first cooled fluid stream is decreased from about 105° F. to about 60° F.

Another embodiment of an olefin production system includes a fluid catalytic cracking unit containing (i) a riser reactor configured to receive a hydrocarbon feedstock stream and a catalyst and produce a cracked product stream containing light and heavy paraffinic hydrocarbons, naphthas, aromatics and olefinic hydrocarbons along with a spent catalyst; (ii) a regenerator in communication with the riser reactor and configured to receive the spent catalyst and regenerate the spent catalyst to produce an entrained catalyst containing inerts entrained with a regenerated catalyst; (iii) a stripper in communication with the regenerator and configured to receive the entrained catalyst and produce the regenerated catalyst by removing the inerts contained within the entrained catalyst; and (iv) a conduit to supply the regenerated catalyst to the riser reactor. The system also includes a fractionator in fluid communication with the fluid catalytic cracking unit and configured to receive and separate the cracked product stream into (i) a vapor product stream containing ethylene and propylene, and light naphtha, (ii) a first wild naphtha product stream, and (iii) a liquid products stream containing one or more of heavy naphtha, a light cycle oil, and a slurry oil. The system also includes a vapor recovery unit in fluid communication with the fractionator and configured to receive the vapor product stream and producing an olefin enriched product stream. In certain embodiments, the riser reactor is a dual or a multi-riser reactor. In certain embodiments, the regenerated catalyst is produced by removing about 75 percent of the inerts contained within the entrained catalyst. In certain embodiments, the regenerated catalyst is produced by removing about 85 percent of the inerts contained within the entrained catalyst. In certain embodiments, the riser reactor is configured to receive two or more hydrocarbon feedstock streams and the catalyst. In certain embodiments, the riser reactor includes a quench line to introduce a quench fluid to the riser reactor at 1.5 seconds after the hydrocarbon feedstock stream is brought in contact with the catalyst.

Another embodiment of an olefin production system includes a fluid catalytic cracking unit containing (i) a riser reactor configured to receive a hydrocarbon feedstock stream and a catalyst and produce a cracked product stream containing light and heavy paraffinic hydrocarbons, naphthas, aromatics and olefinic hydrocarbons along with a spent catalyst; (ii) a regenerator in communication with the riser reactor and configured to receive the spent catalyst and regenerate the spent catalyst to produce an entrained catalyst containing inerts entrained with a regenerated catalyst; (iii) a stripper in communication with the regenerator and configured to receive the entrained catalyst and produce the regenerated catalyst by removing the inerts contained within the entrained catalyst; and (iv) a conduit to supply the regenerated catalyst to the riser reactor. This system may also include a fractionator in fluid communication with the fluid catalytic cracking unit and configured to receive and separate the cracked product stream into (i) a vapor product stream containing ethylene and propylene, and light naphtha, (ii) a first wild naphtha product stream, and (iii) a liquid products stream containing one or more of heavy naphtha, a light cycle oil, and a slurry oil. This system may also include a gas concentration unit containing an overhead condenser, a chiller, a receiver, and a wet gas compressor. The overhead condenser is in fluid communication with the fractionator and configured to receive the vapor product stream and produce a first cooled fluid stream with a temperature ranging from about 105 degrees OF to about 120° F. The chiller, in the gas concentration unit, in fluid communication with the overhead condenser and configured to receive the first cooled fluid stream and produce a second cooled fluid stream with a temperature ranging from about 55° F. to about 100° F. The receiver, in the gas concentration unit, is in fluid communication with the chiller and configured to receive the second cooled fluid stream and separate the second cooled fluid stream to a wet gas stream containing the ethylene and the propylene and a second wild naphtha stream. The wet gas compressor, in the gas concentration unit, may be in fluid communication with the receiver and configured to increase pressure of the wet gas stream containing the ethylene and the propylene to be supplied for downstream processing to produce an olefin enriched product stream. In certain embodiments, the wet gas compressor may increase the pressure of the wet gas stream from 20 pounds per square inch gauge (psig) to 225 psig to be supplied for the downstream processing. In certain embodiments, the temperature of the first cooled fluid stream may range from about 105° F. to about 115° F. In certain embodiments, the temperature of the second cooled fluid stream may range from about 55° F. to about 75° F. or from about 55° F. to about 65° F. In certain embodiments, the riser reactor is configured to receive two or more hydrocarbon feedstock streams. In certain embodiments, the riser reactor is a dual or a multi-riser reactor. In certain embodiments, a volumetric flow rate of the wet gas stream is reduced by about 35 vol. % when the temperature of the first cooled fluid stream is decreased from about 105° F. to about 60° F. In certain embodiments, the regenerated catalyst is produced by removing about 75 percent of the inerts contained within the entrained catalyst. In certain embodiments, the regenerated catalyst is produced by removing about 85 percent of the inerts contained within the entrained catalyst. In certain embodiments, the riser reactor includes a quench line to introduce a quench fluid to the riser reactor to reduce the contact time of one of the two or more hydrocarbon feedstock streams with the catalyst by at 0.5 seconds or more.

Delimiting the gas plant may involve a reduction of the load on the gas concentration unit (GCU), including the wet gas compressor. The combination of the MAXOFIN™ technology with the reduction of the load on the wet gas compressor can maximize propylene yields at a gas plant. The present disclosure generally is directed to several embodiments of methods and systems of delimiting a gas plant during a FCCU revamp to increase propylene yield.

### BRIEF DESCRIPTION OF DRAWINGS

These embodiments and other features, aspects, and advantages of the disclosure will be better understood in conjunction with the following descriptions, claims, and accompanying drawings. It is to be noted, however, that the drawings illustrate only certain embodiments of the disclosure and, therefore, are not to be considered limiting of the scope of the disclosure.

FIG. 1 is an illustrative flow diagram of an olefin production system with a FCCU and a chiller system in a gas concentration unit to delimit a wet gas compressor, according to an embodiment of the disclosure.

FIG. 2 is an illustrative flow diagram of a catalytic cracking unit with a regenerator and a stripper, according to an embodiment of the disclosure.

FIG. 3 is an illustrative flow diagram of a catalytic cracking unit with a regenerator and a quench, according to an embodiment of the disclosure.

FIG. 4 is an illustrative flow diagram of an olefin production system with (i) a catalytic cracking unit with a regenerator and a stripper and (ii) a chiller in a gas concentration unit to delimit a wet gas compressor, according to an embodiment of the disclosure.

### DETAILED DESCRIPTION

So that the manner in which the features and advantages of the embodiments of the methods and systems disclosed herein, as well as others, which will become apparent, may be understood in more detail, a more particular description of embodiments of methods and systems is provided. In the following description, numerous details are set forth in order to provide a thorough understanding of the various embodiments. In other instances, well-known processes, devices, and systems may not been described in particular detail in order not to unnecessarily obscure the various embodiments. Additionally, illustrations of the various embodiments may omit certain features or details in order to not obscure the various embodiments.

Provided herein are several methods and systems that may be implemented individually or in various combinations to delimit a gas plant in an olefin production system to facilitate higher propylene yields. Hydrocarbon feedstocks may consist of heavy feedstocks that include heavy atmospheric gas oils, vacuum gas oils, deasphalted oil (DAO), and/or atmospheric residue. Hydrocarbon feedstock may also consist of light hydrocarbon feedstocks that include light paraffinic, naphthenic, or olefinic hydrocarbons. A FCCU may be utilized to facilitate the cracking of a hydrocarbon feedstock for conversion into valuable products, such as ethylene and propylene. Existing FCC units can be revamped or a new grassroots FCC unit can be designed with improved technology, including but not necessarily limited to MAXOFIN™ technology available from KBR, to produce light olefins such as ethylene and propylene from a light naphtha stream. The MAXOFIN™ technology is a process that enables refiners to maximize propylene production by 20% or more with significantly less ethylene than traditional steam cracking. The olefin production system contains three main sections: the FCCU, the main fractionator, and the gas plant section which can include a gas concentration unit (GCU) within a larger vapor recovery unit (VRU). In certain embodiments, the olefin production system is a unit deploying the MAXOFIN™ technology. The GCU may include an overhead condenser, a chiller, a receiver, and a wet gas compressor, in fluid communication with other equipment, such as a stripper and a primary absorber, that may be used to process the valuable products.

The terms herein “heavy naphtha” or “full range naphtha” refers to a mixture of C6 and greater hydrocarbons with an approximate boiling range from 340° F. to 460° F.; “wild naphtha” refers to a mixture of C6 and greater hydrocarbons with an approximate boiling range from 330 OF to 415° F. having some lighter components; and “light naphtha” refers to a mixture of C5 and greater hydrocarbons with an approximate boiling range from 120° F. to 350° F.

The term “about” refers to a range of values including the specified value, which a person of ordinary skill in the art would consider reasonably similar to the specified value. In embodiments, “about” refers to values within a standard deviation using measurements generally acceptable in the art. In one non-limiting embodiment, when the term “about” is used with a particular value, then “about” refers to a range extending to ±10% of the specified value, alternatively ±5% of the specified value, or alternatively ±1% of the specified value, or alternatively ±0.5% of the specified value. In embodiments, “about” refers to the specified value.

The term “enriched” by a component refers to a stream that contains greater than about 10% by weight of that component, or greater than about 15% by weight, or greater than about 20% by weight, or greater than about 25% by weight, or greater than about 30% by weight.

Embodiments include an olefin production system to delimit a wet gas compressor in a gas concentration unit. One such system includes a FCCU, a fractionator, an overhead condenser, and a gas concentration unit with a chiller, a receiver, and a wet gas compressor. The FCCU contains a riser reactor and a regenerator. The gas plant design and operating conditions may include a riser reactor with two, three, four or even more risers. A hydrocarbon feedstock is supplied to the FCCU and is converted to a cracked product stream containing light and heavy paraffinic hydrocarbons, naphthas, aromatics and olefinic hydrocarbons. In certain embodiments, the riser reactor is configured to receive two or more different hydrocarbon feedstock streams and the catalyst. The riser reactor in the FCCU may include a quench line to introduce a quench fluid to the riser reactor at 1.5 seconds after the hydrocarbon feedstock is brought in contact with a catalyst. This interaction allows the production of a particular product profile of the cracked product stream, such as increase in production of olefins. A fractionator is in fluid communication with the fluid catalytic cracking unit and configured to receive and separate the cracked product stream into (i) a vapor product stream, containing ethylene and propylene, and light naphtha, (ii) a first wild naphtha product stream, and (iii) a liquid products stream containing one or more of heavy naphtha, a light cycle oil, and a slurry oil. An overhead condenser is in fluid communication with the fractionator and configured to receive the vapor product stream and produce a first cooled fluid stream. In certain embodiments, the first cooled fluid stream has a temperature ranging from about 105 degrees OF to about 120° F. In certain embodiments, the temperature of the first cooled fluid stream may range from about 100° F. to about 120° F., or from about 105° F. to about 115° F., or from about 100° F. to about 115° F., or from about 100° F. to about 110° F. The chiller, in the gas concentration unit, is in fluid communication with the overhead condenser and is configured to receive the first cooled fluid stream and produce a second cooled fluid stream. In certain embodiments, the second cooled fluid stream has a temperature ranging from about 55° F. to about 100° F. In certain embodiments, the temperature of the first cooled fluid stream may range from about 55° F. to about 90° F., or from about 55° F. to about 85° F., from about 55° F. to about 75° F., from about 55° F. to about 65° F. The receiver, in the gas concentration unit, is in fluid communication with the chiller and configured to receive the second cooled fluid stream and separate the second cooled fluid stream to a wet gas stream containing the ethylene and the propylene and a second wild naphtha stream. The wet gas compressor, in the gas concentration unit, is in fluid communication with the receiver and configured to increase pressure of the wet gas stream containing ethylene and propylene to be supplied for downstream processing. In certain embodiments, the wet gas compressor may increase the pressure of the wet gas stream from about 20 pounds per square inch gauge (psig) to about 225 psig to be supplied for downstream processing. In certain embodiments, a volumetric flow rate of the wet gas stream is reduced by about 35 vol. % when the temperature of the first cooled fluid stream is decreased from about 105° F. to about 60° F. In certain embodiments, introduction of the chiller results in reduction of the volumetric flow rate of the wet gas stream by about 5 vol. %, or about 10 vol. %, or about 15 vol. %, or about 17 vol. %, or about 20 vol. %, or about 25 vol. %, or about 30 vol. %, or about 40 vol. %. In certain embodiments, the systems described herein may result in an increased propylene yield of at least 3 weight percent (wt. %), or about 4 wt. %, or about 5 wt. %, or about 5.5 wt. %, or about 6 wt. %, or about 6.5 wt. %, or about 7 wt. %, or about 8 wt. %, or about 10 wt. %, or about 15 wt. %, or about 20 wt. %.

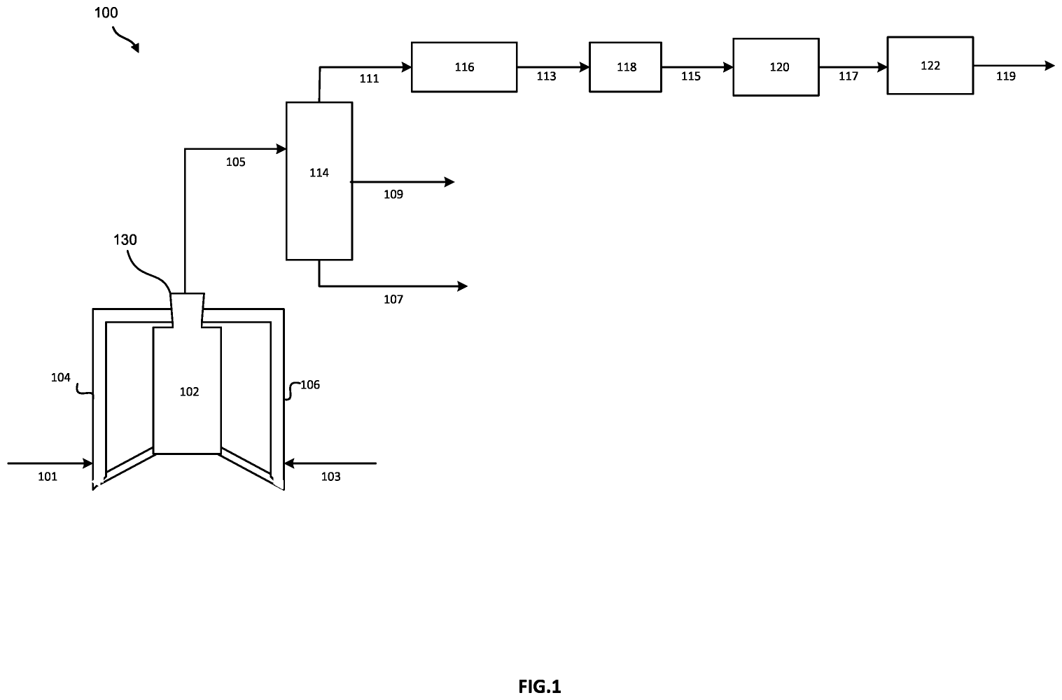

FIG. 1 is an illustrative flow diagram of an olefin production system with a FCCU and a chiller system in a gas concentration unit to delimit a wet gas compressor, according to an embodiment of the disclosure. In certain embodiments, an olefin production system 100 contains a fluid catalytic cracking unit 130 having a reactor with dual risers 104, 106 and a regenerator 102. In such embodiment, two or more hydrocarbon feedstock streams 101 and 103 are received by the dual risers 104 and 106, respectively. The two or more hydrocarbon feedstock streams may be identical or different feedstocks. The dual risers 104, 106 allow for production of a cracked product stream 105. The cracked product stream 105 contains light and heavy paraffinic hydrocarbons, naphthas, aromatics, and olefinic hydrocarbons. The olefin production system 100 further contains a fractionator 114 in fluid communication with the fluid catalytic cracking unit 130. The fractionator 114 is configured to receive the cracked product stream 105 from the dual risers 104, 106 and separate the cracked product stream 105 into (i) a vapor product stream 111 containing ethylene and propylene, and light naphtha, (ii) a first wild naphtha product stream 109, and (iii) a liquid products stream 107 containing one or more of heavy naphtha, a light cycle oil, and a slurry oil. The olefin production system 100 includes a GCU containing one or more of an overhead condenser 116, a chiller 118, a receiver 120, and a wet gas compressor 122. The overhead condenser 116 is in fluid communication with the fractionator 114 and is configured to receive the vapor product stream 111 from the fractionator 114 and produce a first cooled fluid stream 113 with a temperature ranging from about 105 degrees OF to about 115° F. The chiller 118 is in fluid communication with the overhead condenser 116 and is configured to receive the first cooled fluid stream 113 from the overhead condenser 116 and produce a second cooled fluid stream 115 with a temperature ranging from about 60° F. to about 100° F. The chiller reduces the temperature of the inlet streams to the downstream processing units within the GCU, which leads to decreased volumetric flow rate through the downstream processing units.

The olefin production system 100 further contains a receiver 120 in fluid communication with the chiller 118. The receiver 120 is configured to receive the second cooled fluid stream 115 from the chiller 118 and process the second cooled fluid stream 115 to a wet gas stream 117 containing ethylene and propylene and a second wild naphtha stream.

The olefin production system 100 also contains a wet gas compressor 122 in fluid communication with the receiver 120. The wet gas compressor 122 is configured to receive the wet gas stream 117 from the receiver 120 and increase the pressure of the wet gas stream 117 containing ethylene and propylene, such as from 20 psig to 225 psig. This wet gas stream at increased pressure 119 is supplied for downstream processing. As the chiller 118 reduces the temperature of the wet gas stream 117 that is fed to the wet gas compressor 122, the volumetric flow rate of the wet gas stream 117 through the wet gas compressor 122 is reduced. The GCU may contain a suction drum. The suction drum is configured to receive the wet gas stream 117 from the receiver 120 and knock off heavier components from the wet gas stream 117 prior to the wet gas stream 117 being supplied the wet gas compressor 122. The pressure conditions of the wet gas stream 117 supplied to the wet gas compressor 122 may be equal to or comparable to the pressure of a wet gas stream supplied to a compressor in a standard GCU without a chiller. The temperature of the wet gas stream 117 is considerably lesser than the temperature of the wet gas stream supplied to a compressor in a standard GCU without a chiller. The amount of volumetric flow rate reduction may depend on the type of FCCU used with different hydrocarbon feedstocks, operating conditions such as pressure and temperature, and other process conditions applied to the GCU. As a non-limiting example, when the temperature of a wet gas stream produced in the system described herein was decreased from about 100° F. to about 60° F., the volumetric flow rate was reduced by 35% compared to a wet gas processed in a standard GCU without a chiller. As a non-limiting example, due to the reduced suction flow rate of a wet gas stream produced in the system described herein, there was a propylene yield increase by at least about 6.6 weight percent (wt. %) based on modeling data.

Embodiments also include methods for delimiting a gas plant utilizing a chiller system downstream of the fractionation overhead condenser during a FCCU unit revamp. One such method of delimiting a gas plant during a FCCU revamp involves directing a hydrocarbon feedstock stream to a riser reactor of a FCCU. The riser reactor produces a cracked product stream. The method further includes directing the cracked product stream from the riser reactor to a fractionator to produce a vapor product stream, a first wild naphtha stream, and a liquid products stream. The method can further involve the step of directing the vapor product stream from the fractionator to a GCU containing an overhead condenser, a chiller, a receiver, and a wet gas compressor. The overhead condenser and the chiller reduce the temperature and the flow rate of the vapor product stream. Reducing the temperature of the vapor product may also involve directing the vapor product stream from the fractionator to the overhead condenser to produce a first cooled fluid stream. The first cooled fluid stream may have a temperature ranging from about 100° F. to about 120° F. The method further includes directing the first cooled fluid stream from the overhead condenser to a chiller to produce a second cooled fluid stream. The second cooled fluid stream may have a temperature ranging from about 55° F. to about 100° F. The method further includes directing the second cooled fluid stream from the chiller to a receiver to produce a wet gas stream; and directing the wet gas stream from the receiver to a wet gas compressor to produce a wet gas stream at an increased pressure for downstream processing. The reduction of the temperature of the wet gas stream before being supplied to the wet gas compressor also reduces the wet gas compressor suction flow rate.

The riser reactor may include two, three, four or even more riser reactors. In certain embodiments, the riser reactor is configured to receive two or more hydrocarbon feedstock streams. Each of the riser reactors may receive one of the two or more hydrocarbon feedstock streams. The two or more hydrocarbon feedstock streams may be the same or different feedstocks.

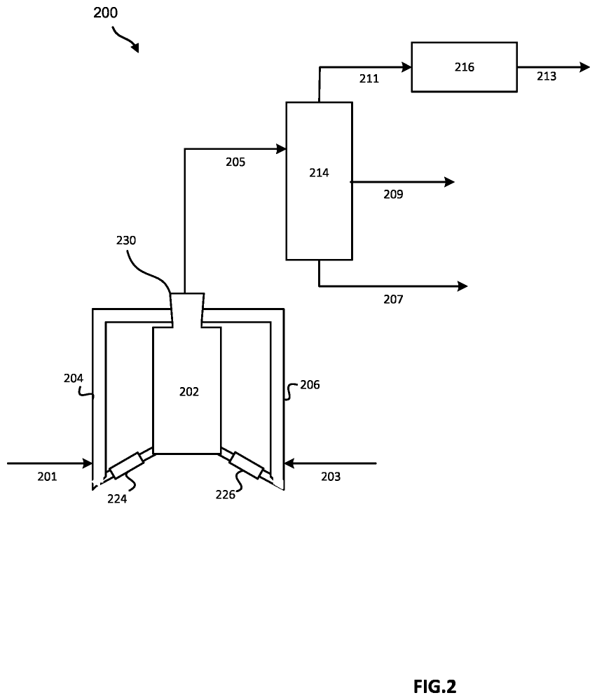

FIG. 2 is an illustrative flow diagram of a catalytic cracking unit with a regenerator and a stripper, which facilitates delimiting a wet gas compressor in a gas concentration unit of an olefin production system 200, according to an embodiment of the disclosure. The olefin production system 200 includes a fluid catalytic cracking unit 230 with a dual riser reactor 204, 206. The reactor with dual risers 204, 206 is configured to receive two or more hydrocarbon feedstock streams 201, 203 and a catalyst to produce a cracked product stream 205 containing light and heavy paraffinic hydrocarbons, naphthas, aromatics and olefinic hydrocarbons along with the spent catalyst. The fluid catalytic cracking unit 230 further includes a regenerator 202 in communication with the dual riser reactor 204, 206. The regenerator 202 is configured to receive the spent catalyst from the dual riser reactor 204, 206 and regenerate the spent catalyst to produce an entrained catalyst containing inerts entrained with a regenerated catalyst. The regenerator 202 may operate at a temperature range from about 1250° F. to about 1400° F. and at a pressure range from about 35 to about 55 psig. The fluid catalytic cracking unit 230 also includes strippers 224, 226 placed downstream of the regenerator 202. The strippers 224, 226 are configured to receive the entrained catalyst from the dual riser reactor 204, 206 and produce the regenerated catalyst by removing the inerts contained within the entrained catalyst. The stripper may be operated at or near the temperature and pressure of the regenerator at a temperature range from about 1250° F. to about 1400° F. and at a pressure range from about 35 to about 55 psig. The stripper may contain structured packing and/or vapor/gas stripping media. The stripper may be supplied with air, steam, nitrogen, or similar stripping gas to remove inerts or other materials from the entrained catalyst. The embodiments may include a single stripper that supplies the regenerated catalyst to two risers. The inerts are combustion products resulting from the burning of the carbonaceous deposits on the spent catalyst, depending on the reactivity of the compounds with the catalyst under the FCC conditions. Inerts may include carbon oxides, hydrogen sulfides, sulfur oxides, water, and nitrogen. The fluid catalytic cracking unit 230 further includes a conduit to supply the regenerated catalyst to a riser of the dual riser reactor 204, 206. The olefin production system 200 further includes a fractionator 214 in fluid communication with the fluid catalytic cracking unit 230. The fractionator 214 is configured to receive the cracked product stream 205 and separate the cracked product stream 205 into (i) a vapor product stream 211 containing ethylene and propylene, and light naphtha, (ii) a first wild naphtha product stream 209, and (iii) a liquid products stream 207 containing one or more of heavy naphtha, a light cycle oil, and a slurry oil. The olefin production system 200 also includes a vapor recovery unit 216 in fluid communication with the fractionator 214. The vapor recovery unit is configured to receive the vapor product stream 211 from the fractionator 214 and produce an olefin enriched product stream 213. The removal of the inerts contained within the entrained catalyst with a stripper in addition to the spent catalyst being regenerated by the regenerator, may provide a propylene yield increase by at least 1.15 wt. % based on FCC modeling data.

Embodiments also include methods for delimiting a gas plant utilizing a regenerator and a stripper during a FCCU unit revamp, such as system described in FIG. 2. One such method of delimiting a gas plant during a FCCU revamp involves directing a hydrocarbon feedstock stream and a catalyst to a riser reactor. In the riser reactor, the hydrocarbon feedstock is subject to fluid catalytic cracking to produce a cracked product stream and spent catalyst. The method further includes directing the cracked product stream from the riser reactor to a fractionator to produce a vapor product stream, a first wild naphtha stream, and a liquid products stream. The method may further involve directing the vapor product stream to a vapor recovery unit to produce an olefin enriched product stream. The method includes directing the spent catalyst to a regenerator to regenerate the spent catalyst to produce an entrained catalyst. The method further includes directing the entrained catalyst to a stripper to produce a regenerated catalyst. In certain embodiments, the regenerated catalyst is produced by removing about 40 percent of the inerts contained within the entrained catalyst. In certain embodiments, the regenerated catalyst is produced by removing about 50%, or about 60%, or about 65%, or about 70%, or about 75%, or about 80%, or about 85% of the inerts contained within the entrained catalyst. In certain embodiments, the regenerated catalyst is produced by removing substantially all of the inerts contained within the entrained catalyst. In certain embodiments, the systems and methods described herein may result in an increased propylene yield of at least 0.5 wt. %, or about 0.75 wt. %, or about 1 wt. %, or about 1.15 wt. %, or about 1.2 wt. %, or about 1.5 wt. %, or about 1.75 wt. %, or about 2 wt. %, or about 3 wt. %, or about 3.5 wt. %.

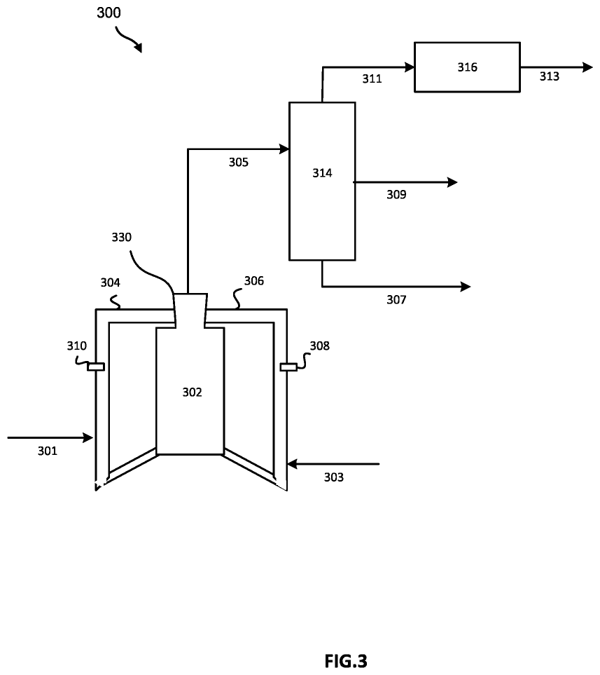

FIG. 3 is an illustrative flow diagram of a catalytic cracking system with a regenerator and a quench line, which facilitates delimiting a wet gas compressor in a gas concentration unit of an olefin production system 300, according to an embodiment of the disclosure. In certain embodiments, the olefin production system 300 contains a fluid catalytic cracking unit 330 with a dual riser reactor 304, 306. The reactor with dual risers 304, 306 is configured to receive two or more hydrocarbon feedstock streams 301, 303 and a catalyst to produce a cracked product stream 305 containing light and heavy paraffinic hydrocarbons, naphthas, aromatics and olefinic hydrocarbons. The two or more hydrocarbon feedstock streams may be the same or different feedstocks. The dual risers 304, 306 are configured to include two quench lines 308, 310 to reduce the catalytic reaction between the hydrocarbon feedstock and catalyst by introduction of a quench fluid. The quench fluid may be heavy naphtha and distillates. The quench fluid is inert to cracking, e.g. water, steam, or a selected hydrocarbon. In certain embodiments, the contact time between the hydrocarbon feedstock streams 301, 303 and the catalyst in the riser may be reduced by introducing a quench fluid at a contact time of 1.5 second after a hydrocarbon feedstock is brought in contact with the catalyst (as compared to the base case contact time of 2 seconds) along the riser has been considered. The contact time may depend on the dimensions of the riser and the flow rate of the hydrocarbon feedstock through the riser. Introduction of the quench fluid results in reducing the dry gas generation and offloading of the wet gas compressor. The riser contact time may also be reduced by hardware modifications to the riser size. The contact time with different riser dimensions may be developed using modeling principles applicable to FCC reactions. The fluid catalytic cracking unit 330 includes a regenerator 302 in communication with the dual riser reactor 304, 306. The regenerator 302 is configured to receive the spent catalyst from the dual risers 304, 306 and regenerate the spent catalyst to produce a regenerated catalyst. The fluid catalytic cracking unit 330 further contains conduits to supply the regenerated catalyst to a riser of the dual riser reactor 304, 306. The olefin production system 300 also includes a fractionator 314 in fluid communication with the fluid catalytic cracking unit 330. The fractionator 314 is configured to receive the cracked product stream 305 and separate the cracked product stream 305 into (i) a vapor product stream 311 containing ethylene and propylene, and light naphtha, (ii) a first wild naphtha product stream 309, and (iii) a liquid products stream 307 containing one or more of heavy naphtha, a light cycle oil, and a slurry oil. The olefin production system 300 further includes a vapor recovery unit 316 in fluid communication with the fractionator 314. The vapor recovery is configured to receive the vapor product stream 311 from fractionator 314 and produce an olefin enriched product stream 313. As a non-limiting example, due to the reduced reaction between the hydrocarbon feedstock and the catalyst in the system described herein, there was a propylene yield increase by at least about 3.30 wt. % based on FCC modeling data.

Embodiments also include methods for delimiting a gas plant a regenerator and a quench line during a FCCU unit revamp. One such method of delimiting a gas plant during a FCCU revamp involves directing a hydrocarbon feedstock stream and a catalyst to the riser reactor. In the riser reactor, the hydrocarbon feedstock is subject to fluid catalytic cracking to produce a cracked product stream and spent catalyst. The method may further include directing a quenching fluid from a quench line in communication with the riser reactor at around 1.5 seconds after a hydrocarbon feedstock is brought in contact with the catalyst to reduce contact time between the hydrocarbon feedstock and the catalyst. The method further includes directing the cracked product stream from the riser reactor to a fractionator to produce a vapor product stream, a first wild naphtha stream, and a liquid products stream. The method may further involve directing the vapor product stream to a vapor recovery unit to produce an olefin enriched product stream. In certain embodiments, the systems and methods described herein may result in an increased propylene yield of at least 1 wt. %, or about 1.5 wt. %, or about 2 wt. %, or about 2.25 wt. %, or about 2.5 wt. %, or about 3 wt. %, or about 3.1 wt. %, or about 3.2 wt. %, or about 3.3 wt. %, or about 3.5 wt. %, or about 4 wt. %, or about 4.5 wt. %, or about 5 wt. %, or about 6 wt. %.

Embodiments of an olefin production system include a modified FCCU containing a riser reactor, a regenerator, and a stripper. The riser reactor is configured to receive a hydrocarbon feedstock stream and a catalyst and produce a cracked product stream containing light and heavy paraffinic hydrocarbons, naphthas, aromatics and olefinic hydrocarbons along with a spent catalyst. The regenerator is in communication with the riser reactor and configured to receive the spent catalyst and regenerate the spent catalyst to produce an entrained catalyst containing inerts entrained with a regenerated catalyst. A stripper is placed in communication with the regenerator and configured to receive the entrained catalyst and produce the regenerated catalyst by removing the inerts contained within the entrained catalyst; and a conduit to supply the regenerated catalyst to the riser reactor. In certain embodiments, a fractionator is in fluid communication with the fluid catalytic cracking unit and configured to receive and separate the cracked product stream into (i) a vapor product stream containing ethylene and propylene, and light naphtha, (ii) a first wild naphtha product stream, and (iii) a liquid products stream containing one or more of heavy naphtha, a light cycle oil, and a slurry oil. In certain embodiments, a vapor recovery unit is in fluid communication with the fractionator and configured to receive the vapor product stream and producing an olefin enriched product stream. In certain embodiments, the riser may include a quench line to introduce a quench fluid to the riser reactor after the hydrocarbon feedstock stream is brought in contact with the catalyst. In certain embodiments, the quench fluid is introduced to reduce the reaction time of the fluid cracking of the hydrocarbon feedstock stream by 10% or by 20% or by 30% to achieve a specific product profile of the cracked product stream. The quench fluid may be added at 1.5 seconds after the hydrocarbon feedstock is brought in contact with a catalyst as compared to the base reaction time of 2 seconds.

In certain embodiments, the riser reactor is configured to receive two or more hydrocarbon feedstock streams and the catalyst. The riser reactor may include two, three, four or even more riser reactors. In certain embodiments, the riser reactor is configured to receive two or more hydrocarbon feedstock streams. Each of the riser reactors may receive one of the two or more hydrocarbon feedstock streams. The two or more hydrocarbon feedstock streams may be the same or different feedstocks.

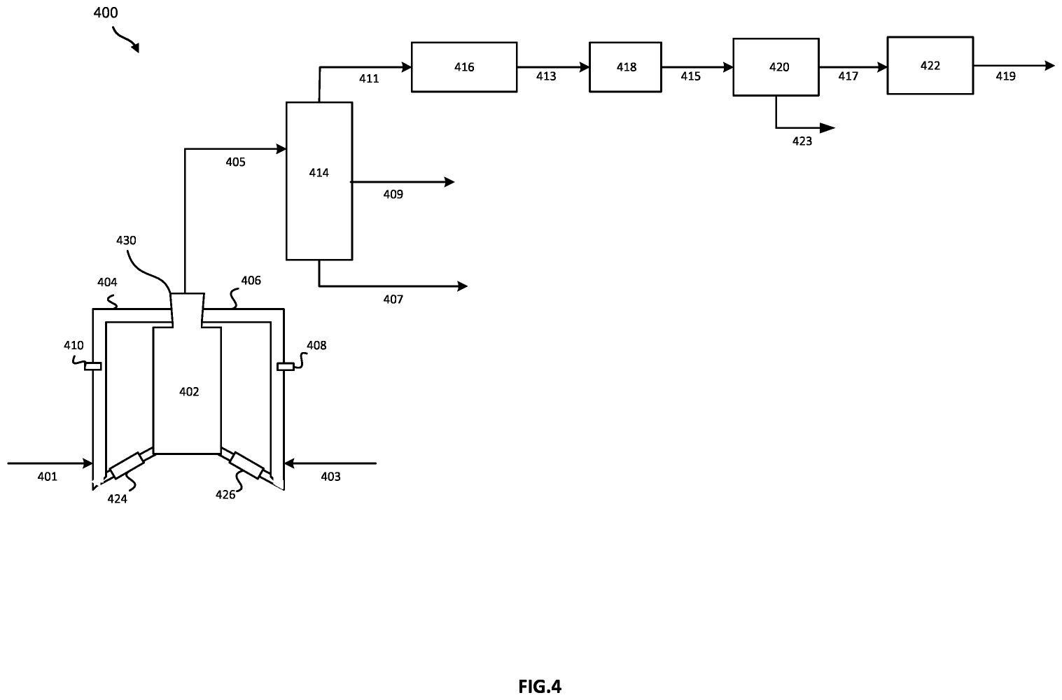

FIG. 4 is an illustrative flow diagram of an olefin production system 400 with a catalytic cracking unit 430 with a regenerator, a stripper, and a chiller system in a gas concentration unit to delimit a wet gas compressor, according to an embodiment of the disclosure. The fluid cracking unit 430 contains a dual riser reactor 404, 406 configured to receive two or more hydrocarbon feedstocks 401, 403 and a catalyst to produce a cracked product stream 405 containing light and heavy paraffinic hydrocarbons, naphthas, aromatics and olefinic hydrocarbons along with the spent catalyst. The dual riser reactor 404, 406 is configured to include two quench lines 408, 410 to reduce the catalytic reaction between the hydrocarbon feedstock 401, 403 and catalyst by introduction of a quench fluid. The fluid cracking unit 430 further contains a regenerator 402 in communication with the dual risers 404, 406. The regenerator 402 is configured to receive from the dual riser reactor 404, 406 the spent catalyst to regenerate the spent catalyst and produce an entrained catalyst containing inerts entrained with a regenerated catalyst. The fluid cracking unit 430 also contains a stripper 424, 426 in communication with the regenerator 402. The stripper is configured to receive the entrained catalyst from the regenerator 402 and produce the regenerated catalyst by removing the inerts contained within the entrained catalyst. The fluid cracking unit 430 further includes a conduit to supply the regenerated catalyst to a riser of the dual riser reactor 404, 406. The regenerated catalyst along with two or more hydrocarbon feedstocks may be used to produce the cracked product stream.

The olefin production system 400 further contains a fractionator 414 that is in fluid communication with the fluid catalytic cracking unit 430. The fractionator 414 is configured to receive the cracked product stream 405 from the dual risers 404, 406 and separate the cracked product stream 405 into (i) a vapor product stream 411 that contains ethylene and propylene, and light naphtha, (ii) a first wild naphtha product stream 409, and (iii) a liquid products stream 407 that contains one or more of heavy naphtha, a light cycle oil, and a slurry oil. The olefin production system 400 also includes an overhead condenser 416 that is in fluid communication with the fractionator 414. The overhead condenser 416 is configured to receive the vapor product stream 411 from the fractionator 414 and produce a first cooled fluid stream 413 with a temperature ranging from about 100° F. to about 120° F. The olefin production system 400 further includes a chiller 418 that is in fluid communication with the overhead condenser 416. The chiller 418 is configured to receive the first cooled fluid stream 413 from the overhead condenser 416 and produce a second cooled fluid stream 415 with a temperature ranging from about 60° F. to about 100° F. The olefin production system 400 also includes a receiver 420 in fluid communication with the chiller 418. The receiver 420 is configured to receive the second cooled fluid stream 415 from the chiller 418 and separate the second cooled fluid stream 415 to a wet gas stream 417 containing ethylene and propylene and a second wild naphtha stream 423. The olefin production system 400 contains a wet gas compressor 422 in fluid communication with the receiver 420. The wet gas compressor 422 is configured to receive the wet gas stream 417 from the receiver 420 and increase the pressure of the wet gas stream 417 containing ethylene and propylene to be supplied for downstream processing 419. In certain embodiments, the pressure of the wet gas stream is increased from 20 psig to 225 psig to be supplied for downstream processing.

Embodiments also include methods for delimiting a gas plant utilizing a chiller system on the fractionation overhead condenser during a FCCU unit revamp. One such method of delimiting a gas plant during a FCCU revamp involves directing a product stream enriched in ethylene, propylene or a combination thereof from a fluid catalytic cracking unit to a fractionator. The fluid catalytic cracking unit may include a single riser or dual or multi-risers. For example, the MAXOFIN™ technology uses a dual riser system that maximizes propylene production by 20% or more while reducing the production of ethylene. The MAXOFIN™ technology has proven to be more efficient than traditional steam cracking. Additionally, the MAXOFIN™ technology provides refineries flexibility to operate in different modes of operation depending on market demands. The different modes of operation include operating as a conventional FCC system to produce gasoline or as a propylene FCC system to produce additional propylene. In some embodiments, the gas plant design and operating conditions include the riser reactor with two, three, four, or even more risers.

Different hydrocarbon feedstocks may be cracked in the fluid catalytic cracking unit to produce the first effluent and the second effluent. For example, the first riser is supplied with a hydrocarbon feedstock with heavy oil, and the second riser is supplied with a hydrocarbon feedstock with light oil. An additive may be added to the first riser and the second riser. In certain embodiments, a proprietary MAXOFIN™ additive may be added, available from KBR. As such, the MAXOFIN™ additive may provide an additional benefit in the production of propylene. In certain embodiments, the catalyst includes a FCC base catalyst and a ZSM additive catalyst.

Crystalline aluminosilicates used in the cracking of light hydrocarbon feedstock are exemplified by ZSM-5 and similar catalysts. In certain embodiments, one or more of a CO promoter, sulfur oxides (SOx) additives, and or other additives may be added to the regenerator, which may be later transported to the riser. In some embodiments, the catalyst is heated.

In certain embodiments, the first riser and second riser conditions are different. The different conditions may include temperature, catalyst-to-oil ratio, hydrocarbon partial pressure, steam-to-oil ratio, residence time, or the like, or a combination thereof. In another embodiment, the first riser and second riser conditions are the same. In some embodiments, the first effluent and second effluent from the first riser and second riser are the same. In other embodiments, the first effluent and second effluent are different, either due to introduction of different feedstock or different operating conditions. In certain embodiments, the method further involves processing the first effluent and the second effluent in the fractionator to fractionate the first effluent and the second effluent into several product streams. In certain embodiments, the fractionator may have a top pressure of about 25 psig and a top temperature of about 250° F. The product streams may include (1) a vapor product stream that includes fuel gas, C3s, isobutylenes (C4s), and light naphtha, (2) a wild naphtha product stream, and (3) a fractionator liquid products stream containing one or more of heavy naphtha, a light cycle oil, and a slurry oil.

The method may further involve directing the vapor product stream to a gas concentration unit containing an overhead condenser, a chiller, a receiver, and a wet gas compressor. The overhead condenser and the chiller reduce the temperature and the flow rate of the vapor product stream. Reducing the temperature of the vapor product may also involve directing the vapor product stream from the fractionator to the overhead condenser thereby to reduce the temperature of the stream to about 120° F., or to about 115° F., or to about 110° F., or to about 105° F., or to about 100° F. Reducing the temperature of the vapor product may involve directing the vapor product stream from the overhead condenser to the chiller system to reduce the temperature of the stream 90° F., or to about 80° F., or to about 75° F., or to about 65° F., or to about 62° F., or to about 60° F., or to about 55° F. The overhead condenser can affect the chiller configuration. The chiller system may have a residence time that depends on the physical dimensions and cooling capabilities of the chiller system. The chiller system is rated based on the chilling load. The method may further involve directing the cooled fluid stream to a receiver and a wet gas compressor. The reduction of the wet gas compressor suction temperature also reduces the wet gas compressor suction flow. In certain embodiments, introduction of the chiller results in reduction of the volumetric flow rate of the wet gas stream at the wet gas compressor by about 5 vol. %, or about 10 vol. %, or about 15 vol. %, or about 17 vol. %, or about 20 vol. %, or about 25 vol. %, or about 30 vol. %, or about 40 vol. %, or about 42 vol. %, or about 45 vol. %. In a non-limiting example, the volumetric flow rate at the wet gas compressor may be reduced by 40 percent for a temperature reduction from about 105° F. to about 60 degrees ºF.

Embodiments include methods for delimiting a gas plant utilizing a regenerator catalyst stripper to reduce the catalyst entrained inerts during a FCCU revamp. In an embodiment, a method of delimiting a gas plant during an FCC unit revamp involves directing a spent catalyst from a riser in a fluid catalytic cracking unit to a regenerator. The regenerator produces an entrained catalyst containing inerts entrained with a regenerated catalyst. Removing the inerts from the entrained catalyst increases the propylene yield. Steam may be introduced into the stripper downstream of the regenerator to remove the entrained inerts. The stripper may have baffles that are angled and oriented to provide for even flow over the baffles and to increase the catalyst contact time with steam. The stripper may have a residence time from about 20 seconds to about 50 seconds. The stripper may operate at or near the temperature and pressure of the regenerator. The residence time may provide for the maximum surface area for mass transfer and higher efficiency of the removal of the entrained inerts. The amount of entrained inerts removed may be up to 85% in the regenerated catalysts. The structured packing and stripping media in the stripper will determine the amount of inerts that may be removed. The catalyst contact time may be about 30 seconds.

The method may further involve directing the vapor product stream from the fractionator to a gas concentration unit. The method may also involve directing the fractionator vapor product stream from the fractionator overhead condenser to a wet gas compressor. The amount of entrained inerts removed may reduce the carry over to the fluid catalytic cracking unit. The reduced carryover of entrained inerts may also reduce the load on the wet gas compressor. In certain embodiments, the reduction of the load on the wet gas compressor leads to increased propylene yield.

Embodiments include methods to delimit a gas plant by introducing a quench line to reduce the contact time between the hydrocarbon feedstock and the catalyst in a riser reactor during an FCCU revamp. In an embodiment, a method of delimiting a gas plant during a FCCU revamp may involve directing a first hydrocarbon feedstock and a first catalyst into a first riser. The first riser may have a quench line to introduce a quench fluid to contact the first hydrocarbon feedstock and the first catalyst. In certain embodiments, the method may also involve quenching the first hydrocarbon feedstock with the quench at the first riser contact time 1.5 seconds after the first hydrocarbon feedstock and the first catalyst is introduced into the first riser. In other embodiments, the riser contact time may be reduced by alternative hardware modifications to the fluid catalytic cracking unit. In an embodiment, the method may further involve directing a second hydrocarbon feedstock and a second catalyst in a second riser. The second riser may have a quench line to introduce a quench fluid to contact the second hydrocarbon feedstock and the second catalyst. In an embodiment, the method may also involve quenching the second hydrocarbon feedstock with the quench 1.5 seconds after the second hydrocarbon feedstock and the second catalyst are introduced into the second riser. In other embodiments, the quench fluid may be included to reduce the contact time in the riser by at least 0.5 seconds as compared to a FCCU without this quench line. Alternatively, the riser contact time for the first hydrocarbon feedstock and the second hydrocarbon feedstock may be reduced with an alternative riser modification, as described herein.

Certain embodiments include methods of olefin production with the following steps: (i) directing a product stream enriched in ethylene, propylene or a combination thereof from a fluid catalytic cracking unit to a fractionator to separate the cracked product stream into three streams: a vapor product stream, a first wild naphtha product stream, and a liquid products stream, (ii) directing the vapor product stream to an overhead condenser to produce a first cooled fluid stream with a temperature ranging from about 100° F. to about 120° F., (iii) directing the first cooled fluid stream to a chiller for producing a second cooled fluid stream with a temperature ranging from about 60° F. to about 100° F., (iv) supplying the second cooled fluid stream to a receiver to separate the second cooled fluid stream to a wet gas stream containing ethylene and propylene and a second wild naphtha stream. The wet gas stream is supplied to a wet gas compressor in the gas concentration unit to increase pressure to be supplied for downstream processing. In an embodiment, the method further includes directing a spent catalyst from a riser of the fluid catalytic cracking unit to a regenerator to produce an entrained catalyst containing inerts entrained with a regenerated catalyst. The entrained catalyst is then passed through a stripper to remove the inerts from the entrained catalyst to produce a regenerated catalyst with a significant amount of entrained inerts removed. The method may also include introducing a quench fluid to a riser of the fluid catalytic cracking unit to reduce the contact time between the hydrocarbon feedstock and the catalyst in the riser by at least 0.5 seconds as compared to a FCCU without this quench line.

When ranges are disclosed herein, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, reference to values stated in ranges includes each and every value within that range, even though not explicitly recited. Thus, every point or individual value may serve as its own lower or upper limit combined with any other point or individual value or any other lower or upper limit, to recite a range not explicitly recited.

Other objects, features and advantages of the disclosure will become apparent from the foregoing drawings, detailed description, and examples. These drawings, detailed description, and examples, while indicating specific embodiments of the disclosure, are given by way of illustration only and are not meant to be limiting. In further embodiments, features from specific embodiments may be combined with features from other embodiments. For example, features from one embodiment may be combined with features from any of the other embodiments. In further embodiments, additional features may be added to the specific embodiments described herein. It should be understood that although the disclosure contains certain aspects, embodiments, and optional features, modification, improvement, or variation of such aspects, embodiments, and optional features can be resorted to by those skilled in the art, and that such modification, improvement, or variation is considered to be within the scope of this disclosure.

What is claimed is:

1. An olefin production system, the system comprising:
a fluid catalytic cracking unit containing a riser reactor and a regenerator and configured to receive a hydrocarbon feedstock and produce a cracked product stream containing light and heavy paraffinic hydrocarbons, naphthas, aromatics and olefinic hydrocarbons;
a fractionator in fluid communication with the fluid catalytic cracking unit and configured to receive and separate the cracked product stream into (i) a vapor product stream containing ethylene and propylene, and light naphtha, (ii) a first wild naphtha product stream, and (iii) a liquid products stream containing one or more of heavy naphtha, a light cycle oil, and a slurry oil;
an overhead condenser in fluid communication with the fractionator and configured to receive the vapor product stream and produce a first cooled fluid stream with a temperature ranging from about 105 degrees Fahrenheit (° F.) to about 120° F.;
a chiller, in a gas concentration unit, in fluid communication with the overhead condenser and configured to receive the first cooled fluid stream and produce a second cooled fluid stream with a temperature ranging from about 55° F. to about 100° F.;
a receiver, in the gas concentration unit, in fluid communication with the chiller and configured to receive the second cooled fluid stream and separate the second cooled fluid stream to a wet gas stream containing the ethylene and the propylene and a second wild naphtha stream; and
a wet gas compressor, in the gas concentration unit, in fluid communication with the receiver and configured to increase pressure of the wet gas stream containing the ethylene and the propylene to be supplied for downstream processing to produce an olefin enriched product stream.

2. The olefin production system of claim 1, wherein the temperature of the first cooled fluid stream ranges from about 105° F. to about 115° F.

3. The olefin production system of claim 1, wherein the temperature of the second cooled fluid stream ranges from about 55° F. to about 75° F.

4. The olefin production system of claim 1, wherein the riser reactor is configured to receive two or more hydrocarbon feedstock streams and a cracking catalyst.

5. The olefin production system of claim 1, wherein the wet gas compressor increases the pressure of the wet gas stream from 20 pounds per square inch gauge (psig) to 225 psig to be supplied for the downstream processing.

6. The olefin production system of claim 1, wherein the riser reactor includes a quench line to introduce a quench fluid to the riser reactor at 1.5 seconds after the hydrocarbon feedstock is brought in contact with a catalyst.

7. The olefin production system of claim 1, wherein a volumetric flow rate of the wet gas stream is reduced by about 35 vol. % when the temperature of the first cooled fluid stream is decreased from about 105° F. to about 60° F.

8. An olefin production system, the system comprising:
a fluid catalytic cracking unit containing:
a riser reactor configured to receive a hydrocarbon feedstock stream and a catalyst and produce a cracked product stream containing light and heavy paraffinic hydrocarbons, naphthas, aromatics and olefinic hydrocarbons along with a spent catalyst;
a regenerator in communication with the riser reactor and configured to receive the spent catalyst and regenerate the spent catalyst to produce an entrained catalyst containing inerts entrained with a regenerated catalyst;
a stripper in communication with the regenerator and configured to receive the entrained catalyst and produce the regenerated catalyst by removing the inerts contained within the entrained catalyst; and
a conduit to supply the regenerated catalyst to the riser reactor;
a fractionator in fluid communication with the fluid catalytic cracking unit and configured to receive and separate the cracked product stream into (i) a vapor product stream containing ethylene and propylene, and light naphtha, (ii) a first wild naphtha product stream, and (iii) a liquid products stream containing one or more of heavy naphtha, a light cycle oil, and a slurry oil; and
a vapor recovery unit in fluid communication with the fractionator and configured to receive the vapor product stream and producing an olefin enriched product stream.

9. The olefin production system of claim 8, wherein the regenerated catalyst is produced by removing about 75 percent of the inerts contained within the entrained catalyst.

10. The olefin production system of claim 8, wherein the riser reactor is configured to receive two or more hydrocarbon feedstock streams and the catalyst.

11. The olefin production system of claim 8, wherein the riser reactor includes a quench line to introduce a quench fluid to the riser reactor at 1.5 seconds after the hydrocarbon feedstock stream is brought in contact with the catalyst.

12. An olefin production system, the system comprising:
a fluid catalytic cracking unit containing:
a riser reactor configured to receive a hydrocarbon feedstock stream and a catalyst and produce a cracked product stream containing light and heavy paraffinic hydrocarbons, naphthas, aromatics and olefinic hydrocarbons along with a spent catalyst;
a regenerator in communication with the riser reactor and configured to receive the spent catalyst from the riser reactor and regenerate the spent catalyst to produce an entrained catalyst containing inerts entrained with a regenerated catalyst;
a stripper in communication with the regenerator and configured to receive the entrained catalyst and produce the regenerated catalyst by removing the inerts contained within the entrained catalyst; and
a conduit to supply the regenerated catalyst to the riser reactor;
a fractionator in fluid communication with the fluid catalytic cracking unit and configured to receive the cracked product stream and separate the cracked product stream into (i) a vapor product stream containing ethylene and propylene, and light naphtha, (ii) a first wild naphtha product stream, and (iii) a liquid products stream containing one or more of heavy naphtha, a light cycle oil, and a slurry oil;
an overhead condenser in fluid communication with the fractionator and configured to receive the vapor product stream and produce a first cooled fluid stream with a temperature ranging from about 105 degrees Fahrenheit (° F.) to about 120° F.;
a chiller in fluid communication with the overhead condenser and configured to receive the first cooled fluid stream from the and produce a second cooled fluid stream with a temperature ranging from about 55° F. to about 100° F.;
a receiver in fluid communication with the chiller and configured to receive the second cooled fluid stream and separate the second cooled fluid stream to a wet gas stream containing the ethylene and the propylene and a second wild naphtha stream; and
a wet gas compressor in fluid communication with the receiver and configured to receive the wet gas stream and increase pressure of the wet gas stream containing the ethylene and the propylene to be supplied for downstream processing to produce an olefin enriched product stream.

13. The olefin production system of claim 12, wherein the temperature of the first cooled fluid stream ranges from about 105° F. to about 115° F.

14. The olefin production system of claim 12, wherein the temperature of the second cooled fluid stream ranges from about 55° F. to about 75° F.

15. The olefin production system of claim 12, wherein the riser reactor is configured to receive two or more hydrocarbon feedstock streams and the catalyst.

16. The olefin production system of claim 12, wherein the wet gas compressor increases the pressure of the wet gas stream from 20 pounds per square inch gauge (psig) to 225 psig to be supplied for the downstream processing.

17. The olefin production system of claim 12, wherein the regenerated catalyst is produced by removing about 75 percent of the inerts contained within the entrained catalyst.

18. The olefin production system of claim 12, wherein the regenerated catalyst is produced by removing about 85 percent of the inerts contained within the entrained catalyst.

19. The olefin production system of claim 12, wherein the riser reactor includes a quench line to introduce a quench fluid to the riser reactor at 1.5 seconds after the hydrocarbon feedstock streams is brought in contact with the catalyst.

20. The olefin production system of claim 12, wherein a volumetric flow rate of the wet gas stream is reduced by about 35 vol. % when the temperature of the first cooled fluid stream is decreased from about 105° F. to about 60° F. in the chiller.
